(19) United States
(12) Patent Application Publication
(10) Pub. No.: US 2018/0237598 A1
(43) Pub. Date: Aug. 23, 2018

(54) COLOR MASTERBATCH GLASS-FILLED NYLON COMPOSITES

(71) Applicant: SABIC Global Technologies B.V., Bergen op Zoom (NL)

(72) Inventors: Mingcheng GUO, Shanghai (CN); Feng GONG, Shanghai (CN); Shen ZHANG, Shanghai (CN)

(21) Appl. No.: 15/752,013

(22) PCT Filed: Aug. 8, 2016
(86) PCT No.: PCT/IB2016/054774

§ 371 Date: Feb. 12, 2018

Related U.S. Application Data
(60) Provisional application No. 62/205,449, filed on Aug. 14, 2015.

(51) Int. Cl. C08J 3/22; C08J 5/04; C08J 5/08; C08K 7/14; C08K 3/04; C08L 77/02; C08L 77/06; C08L 51/06; C08K 5/00

(52) U.S. Cl. CPC C08J 3/226; C08J 5/043; C08J 5/08; C08K 7/14; C08K 3/04; C08L 77/02; C08L 23/06; C08L 51/06; C08K 5/0041; C08J 2377/02; C08J 2377/04; C08J 2377/08; C08J 2423/26; C08L 77/06

(57) ABSTRACT

The disclosure concerns glass fiber filled nylon resin composites including a polyolefin based color masterbatch. The compositions further comprise a compatibilizer.

### CROSS REFERENCE TO RELATED APPLICATIONS

The present application claims priority to and the benefit of U.S. application 62/205,449, “Mechanical Properties of Color Masterbatch Glass-Filled Nylon Composites” (filed, Aug. 14, 2015) the entirety of which application is incorporated herein by reference for any and all purposes.

### TECHNICAL FIELD

The disclosure relates to nylon composite resins having polymer-based color masterbatch and glass fiber filler.

### BACKGROUND

Reinforcing fibers can be used to alter the physical properties of a given thermoplastic resin. Depending upon the base resin profile, these fillers can improve flexural strength, impact strength, and stability among other properties. Polyamide resins, commonly known as nylon resins, are commonly reinforced to provide improved tensile, thermal, and processing properties.

### SUMMARY

Nylon-based resins can be filled with reinforcing fibers to impart certain physical properties to the resin. Glass fibers are added to nylon resins to improve tensile or flexural strength, dimensional ability, thermal stability, and wear resistance, and are added as lubricating aids during processing. The filled nylon resins are appropriate for a number of end-use applications, some of which require different colors to meet industry demands. The color is often introduced using a polymer (often a polyolefin)-based color masterbatch. Unfortunately, the most widely used color masterbatches are polyethylene-based which can diminish the properties of glass-filled nylon-based resins. Thus, it would be advantageous to develop a glass fiber filled nylon resin composite that includes a polyolefin-based color masterbatch while not suffering decreased mechanical properties. The above-described and other deficiencies are met by a resin composite including a polyamide base resin, glass fiber, a polyolefin-based color masterbatch, and a compatibilizer.

Embodiments of the present disclosure relate to a resin composite including from 20 wt. % to 90 wt. % of a polyamide base resin; from 8 wt. % to 60 wt. % of glass fiber; from 0.1 wt. % to 10 wt. % of a polyolefin-based color masterbatch; and from 0.1 wt. % to 20 wt. % of a compatibilizer. In further embodiments, the resin composite may include from about 20 wt. % to about 90 wt. % of a polyamide base resin; from about 8 wt. % to about 60 wt. % of glass fiber; from about 0.1 wt. % to about 10 wt. % of a polyolefin-based color masterbatch; and from about 0.1 wt. % to about 20 wt. % of a compatibilizer. The resin composite exhibits an Izod impact strength greater than 10% of a substantially similar resin composite in the absence of the compatibilizer when tested in accordance with ASTM D256 (2010) Notched Izod impact strength and ASTM D4812 (2011) for Unnotched Izod impact strength tests, and wherein the combined weight percent value of all components does not exceed about 100 wt. %, and wherein all weight percent values are based on the total weight of the composition. The resin composite can further include additional additives and processing aids.

Other embodiments of the present disclosure relate to compositions including from 20 wt. % to 90 wt. % of a polyamide base resin; from 8 wt. % to 60 wt. % of glass fiber; from 0.1 wt. % to 10 wt. % of a polyolefin-based color masterbatch; and from 0.1 wt. % to 20 wt. % of a maleated polyolefin. In still further embodiments, the compositions include from about 20 wt. % to about 90 wt. % of a polyamide base resin; from about 8 wt. % to about 60 wt. % of glass fiber; from about 0.1 wt. % to about 10 wt. % of a polyolefin-based color masterbatch; and from about 0.1 wt. % to about 20 wt. % of a maleated polyolefin. The resin composite exhibits an Izod impact strength greater than 10% of a substantially similar resin composite in the absence of the maleated polyolefin, when tested in accordance with ASTM D256 and/or 180, and wherein the combined weight percent value of all components does not exceed about 100 wt. %, and wherein all weight percent values are based on the total weight of the resin composite. The resin composite can further include additional additives and processing aids.

In yet further embodiments, the present disclosure relates to a method of forming a resin composite including a nylon base resin, glass fiber, a polyolefin-based color masterbatch, and a compatibilizer.

In one aspect, the disclosure relates to a method of forming an article comprising the steps of molding an article from the resin composite described herein.

### DETAILED DESCRIPTION

Before the present compounds, compositions, articles, systems, devices, and/or methods are disclosed and described, it is to be understood that they are not limited to specific synthetic methods unless otherwise specified, or to particular reagents unless otherwise specified, as such can, of course, vary. It is also to be understood that the terminology used herein is for the purpose of describing particular aspects only and is not intended to be limiting.

Various combinations of elements of this disclosure are encompassed by this disclosure, e.g., combinations of elements from dependent claims that depend upon the same independent claim.

Moreover, it is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

All publications mentioned herein are incorporated herein by reference to disclose and describe the methods and/or materials in connection with which the publications are cited.

### Definitions

It is also to be understood that the terminology used herein is for the purpose of describing particular aspects only and is not intended to be limiting. As used in the specification and in the claims, the terms “comprising” and/or “including” can include the embodiments “cm³/10 min g of” and “consisting essentially of” Unless defined otherwise, all technical and scientific terms used herein have the same meaning as commonly understood by one of ordinary skill in the art to which this disclosure belongs. In this specification and in the claims which follow, reference will be made to a number of terms which shall be defined herein.

As used in the specification and the appended claims, the singular forms “a,” “an” and “the” include plural referents unless the context clearly dictates otherwise. Thus, for example, reference to “a polyamide resin” includes mixtures of two or more such polyamide resins. Furthermore, for example, reference to a filler includes mixtures of two or more such fillers. As used herein, the term “combination” is inclusive of blends, mixtures, alloys, reaction products, and the like.

Ranges can be expressed herein as from one particular value, and/or to another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

Disclosed are the components to be used to prepare the compositions of the disclosure as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds cannot be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the disclosure. Thus, if there are a variety of additional steps that can be performed it is understood that each of these additional steps can be performed with any specific aspect or combination of aspects of the methods of the disclosure.

References in the specification and concluding claims to parts by weight of a particular element or component in a composition or article, denotes the weight relationship between the element or component and any other elements or components in the composition or article for which a part by weight is expressed. Thus, in a compound containing 2 parts by weight of component X and 5 parts by weight component Y, X and Y are present at a weight ratio of 2:5, and are present in such ratio regardless of whether additional components are contained in the compound.

A weight percent of a component, unless specifically stated to the contrary, is based on the total weight of the formulation or composition in which the component is included.

As used herein the terms “weight percent,” “wt %,” and “wt. %,” which can be used interchangeably, indicate the percent by weight of a given component based on the total weight of the composition, unless otherwise specified. That is, unless otherwise specified, all wt % values are based on the total weight of the composition. It should be understood that the sum of wt % values for all components in a disclosed composition or formulation are equal to 100.

As used herein “a substantially similar resin composite” can refer to a resin composite consisting essentially of certain components and not others. As an example, a substantially similar resin composite may consist essentially of a polyamide base resin, glass fiber, and a polyolefin-based color masterbatch in the absence of a maleated polyolefin compatibilizer.

Unless otherwise stated to the contrary herein, all test standards are the most recent standard in effect at the time of filing this application.

Each of the materials disclosed herein are either commercially available and/or the methods for the production thereof are known to those of skill in the art.

It is understood that the compositions disclosed herein have certain functions. Disclosed herein are certain structural requirements for performing the disclosed functions and it is understood that there are a variety of structures that can perform the same function that are related to the disclosed structures, and that these structures will typically achieve the same result.

### Resin Composite

Glass fiber-filled nylon compositions can have improved tensile and flexural strength as well as improved dimensional strength and thermal stability. Such filled nylon compositions are widely used given their desirable mechanical and physical properties. The broad array of uses can also require that the nylon resin be available in a variety of colors. To achieve an array of hues, a polymer-based color masterbatch such as for example a polyethylene, polypropylene, or acrylonitrile butadiene styrene (ABS) compound can be compounded with the nylon base resin. While a polyethylene-based masterbatch might typically be a desirable choice due to its low melting point and good thermal stability, it has been found that a polyethylene-based color masterbatch can diminish the properties of glass-filled nylon-based resins because polyethylene can be incompatible with both the nylon base resin and the fiber fillers such as glass fiber. The non-polar, hydrophobic characteristics of polyethylene can be less likely to be miscible with the polar, hydrophilic base resin nylon.

The present disclosure thus relates to a resin composite including a polyamide base resin, a glass fiber, a polyolefin-based color masterbatch, and a compatibilizer. In some embodiments, the compatibilizer preserves the enhanced properties of the combined polyamide base resin and glass fiber without suffering diminished properties resulting from the introduction of a polyolefin-based color masterbatch.

In an aspect, the resin composite can include from 20 wt. % to 90 wt. % of a polyamide base resin, from 10 wt. % to 60 wt. % of glass fiber, from 0.1 wt. % to 10 wt. % of a polyolefin-based color masterbatch, and from 0.1 wt. % to 20 wt. % of a compatibilizer. In a further aspect, the resin composite can include from about 20 wt. % to about 90 wt. % of a polyamide base resin, from about 10 wt. % to about 60 wt. % of glass fiber, from about 0.1 wt. % to about 10 wt. % of a polyolefin-based color masterbatch, and from about 0.1 wt. % to about 20 wt. % of a compatibilizer. The combined weight percent value of all components does not exceed about 100 wt. % and all weight percent values are based on the total weight of the composition, and the combined weight percent value of all components does not exceed about 100 wt. %.

### Polyamide Base Resin

The resin composite disclosed herein include a polyamide base resin. Polyamide resins can include a generic family of resins known as nylons which can be characterized by the presence of an amide group (—C(O)NH—). The resins include repeating units linked by an amide group bond.

Polyamide resins may be obtained according to well-known processes such as those described in U.S. Pat. Nos. 2,071,250; 2,071,251; 2,130,523; 2,130,948; 2,241,322; 2,312,966; and 2,512,606. As an example, polyamides can be prepared by polymerizing a monoamine-monocarboxylic acid or a lactam thereof having at least two carbon atoms between the amino and carboxylic acid groups. Polyamides may also be prepared by polymerizing substantially equimolecular proportions of a carboxylic acid and a diamine containing at least two carbon atoms between the amino groups. In further examples, polyamides can be prepared by polymerizing a monoaminocarboxylic acid or a lactam thereof with substantially equimolecular proportions of a diamine and dicarboxylic acid. Polyamide resins are commercially available from a wide variety of sources. As used herein, substantially equimolecular proportions can refer to both equimolecular proportions and the departures therefrom which are involved in conventional techniques to stabilize the viscosity of the resultant polyamide. Copolymers of caprolactam with diacids and diamines are also useful.

Monoaminomonocarboxylic acids or lactams thereof may include compounds having from two to sixteen carbon atoms between the amino can carboxylic acid groups. For lactams, the carbon atoms form ring with the —CO—NH— group. Exemplary aminocarboxylic acids and lactams can include 6-aminocaproic acid, butyrolactam, enantholactam, pivaloactam, caprolactam, undecanolactam, capryllactam, dodecanolactam, and 3- and 4-aminobenzoic acids.

Diamines useful in polyamide preparation may include alkyl, aryl and alkyl-aryl diamines. Suitable diamines may be represented by the general formula H₂N(CH₂)NH₂ where n is an integer from 2 to 16. Exemplary diamines may include, but are not limited to, trimethylenediamine, pentamethylene diamine, tetramethylenediamine, octamethylenediamine, hexamethylenediamine, trimethyl hexamethylene diamine, metaxylylene diamine, meta-phenylene diamine, and the like. Other useful diamines include m-xylyene diamine, di-(4-aminophenyl)methane, di-(4-aminocyclohexyl)methane; 2,2-di-(4-aminophenyl)propane, 2,2-di-(4-aminocyclohexyl)propane, among others. Suitable dicarboxylic acids may be aromatic or aliphatic. Aromatic dicarboxylic acids may include isophthalic and therephthalic acids. Aliphatic dicarboxylic acids may be represented by the formula HOOC—Y—COOH where Y represents a divalent aliphatic group containing at least two carbon atoms. Exemplary dicarboxylic acids may include sebacic acid, suberic acid, octadecanedoic acid, glutaric acid, adipic acid, and pimelic acid. Other useful diacids for the preparation of nylons include azelaic acid, dodecane diacid, as well as terephthalic and isophthalic acids, and the like.

Polyamides may generally include aliphatic polyamides which feature an aliphatic main chain; high performance polyamides which feature repeating units of the semiaromatic polypthalamide molecule; and aramides which feature repeating aromatic units.

Exemplary polyamide resins can include nylon-6 (polyamide 6) and nylon-6,6 (polyamide 6,6) which are available from a variety of commercial sources. Other exemplary polyamides can include nylon-4, nylon-4,6 (PA 46), nylon-12, nylon-6,10, nylon-6,9, nylon-6,12, nylon-9T, copolymer of nylon-6,6 and nylon-6, nylon 610 (PA610), nylon 11 (PA11), nylon 12 (PA 12), nylon 6-3-T (PA 6-3-T), polyarylamid (PA MXD 6), polyphthalamide (PPA) and/or poly-ether-block amide, and others such as the amorphous nylons, may also be useful. Nylon-6, for example, is a polymerization product of caprolactam. Nylon-6,6 is a condensation product of adipic acid and 1,6-diaminohexane. Likewise, nylon 4,6 is a condensation product between adipic acid and 1,4-diaminobutane.

Mixtures of various polyamides, as well as various polyamide copolymers, are also useful. In some examples, the polyamide resin can include a combination of nylon 6 and nylon 6,6 in an amount of from about 20 wt. % to about 90 wt. %.

As noted above, in certain examples the resin composite includes from about 20 wt. % to about 90 wt. % of the polyamide base resin. In other examples the resin composite includes from about 30 wt. % to about 90 wt. % of the polyamide base resin, or from about 40 wt. % to about 90 wt. % of the polyamide base resin, or from about 50 wt. % to about 90 wt. % of the polyamide base resin, or from about 60 wt. % to about 90 wt. % of the polyamide base resin, or from about 70 wt. % to about 90 wt. % of the polyamide base resin, or even from about 80 wt. % to about 90 wt. % of the polyamide base resin.

In yet further examples, the polyamide base resin of the present disclosure may include polyamide resins having a relative viscosity of from about 2 to about 4 when measured in accordance with ISO 307 at a concentration of 1 gram per deciliter in sulfuric acid solvent. In other examples, the polyamide base resin may include polyamide resins having a viscosity of from about 2.4 to about 3.4, or even from about 2.7 to about 3.1. In general, however, the polyamide base resin can have any desirable viscosity ranging from a low viscosity to a high viscosity, particularly where glass fiber loading is low such as in the specific examples discussed herein. In certain examples having relatively higher glass fiber loadings, however, it may be desirable to include a polyamide base resin having a relatively lower viscosity.

### Glass Fiber

The resin composites disclosed herein include a glass fiber. In various aspects, the glass fiber can be a reinforcing filler increasing, for example, the flexural modulus and strength of the polyamide base resin. As an example, the diameter of the glass fiber can range from about 5 μm (micrometer) to about 35 μm. Generally, where a thermoplastic resin is reinforced with glass fibers in a composite form, fibers having a length of about 0.4 mm (millimeter) or longer are referred to long fibers, and fibers shorter than this are referred to as short fibers. In one embodiment, the diameter of the glass fibers can be about 10 μm. In a further embodiment, the glass fibers have a length of 1 mm or longer. In a further example, the glass fibers can have a length of about 3.2 mm (or ⅛ inch).

The glass fibers used in select aspects of this disclosure may be surface-treated with a surface treatment agent containing a coupling agent to improve adhesion to the resin base. Suitable coupling agents can include, but are not limited to, silane-based coupling agents, titanate-based coupling agents or a mixture thereof. Applicable silane-based coupling agents include aminosilane, epoxysilane, amidesilane, azidesilane and acrylsilane. Organo metallic coupling agents, for example, titanium or zirconium-based organo metallic compounds, may also be used. In exemplary embodiments, the glass fiber used in the invention may be selected from E-glass, S-glass, AR-glass, T-glass, D-glass R-glass, and combinations thereof. As an example, the glass fiber can be an “E” glass type which is a class of fibrous glass filaments comprised of lime-alumino-borosilicate glass.

As noted above, in certain examples the resin composite disclosed herein includes from 5 wt. % to 60 wt. %, or from about 5 wt. % to about 60 wt. %, or from 10 wt. % to 60 wt. %, or from about 10 wt. % to about 60 wt. % glass fiber. In other examples, the resin composite includes from 10 wt. % to 50 wt. %, or from about 10 wt. % to about 50 wt. % glass fiber, or 10 wt. % to 40 wt. %, from about 10 wt. % to about 40 wt. % glass fiber, or from 10 wt. % to 30 wt. %, about 10 wt. % to about 30 wt. % glass fiber, or even from 10 wt. % to 20 wt. %, or from about 10 wt. % to about 20 wt. % glass fiber.

### Color Masterbatch

In addition to the polyamide base resin and glass fiber, the resin composites of the present disclosure also include a polyolefin-based color masterbatch to impart color to the resin composite. A color masterbatch, or color concentrate, can include a desired colorant dispersed in an appropriate carrier resin.

The polyolefin-based color masterbatch can include colorants, pigments, or dyes as the color to be dispersed in the desired carrier resin. Suitable pigments include for example, inorganic pigments such as metal oxides and mixed metal oxides such as zinc oxide, titanium dioxides, iron oxides or the like; sulfides such as zinc sulfides, or the like; aluminates; sodium sulfo-silicates; sulfates and chromates; zinc ferrites; ultramarine blue; Pigment Brown 24; Pigment Red 101; Pigment Yellow 119; organic pigments such as azos, di-azos, quinacridones, perylenes, naphthalene tetracarboxylic acids, flavanthrones, isoindolinones, tetrachloroisoindolinones, anthraquinones, anthanthrones, dioxazines, phthalocyanines, and azo lakes; Pigment Blue 60, Pigment Red 122, Pigment Red 149, Pigment Red 177, Pigment Red 179, Pigment Red 202, Pigment Violet 29, Pigment Blue 15, Pigment Green 7, Pigment Yellow 147 and Pigment Yellow 150, or combinations including at least one of the foregoing pigments.

Suitable dyes include, for example, organic dyes such as coumarin 460 (blue), coumarin 6 (green), nile red or the like; lanthanide complexes; hydrocarbon and substituted hydrocarbon dyes; polycyclic aromatic hydrocarbons; scintillation dyes (preferably oxazoles and oxadiazoles); aryl- or heteroaryl-substituted poly (2-8 olefins); carbocyanine dyes; phthalocyanine dyes and pigments; oxazine dyes; carbostyryl dyes; porphyrin dyes; acridine dyes; anthraquinone dyes; arylmethane dyes; azo dyes; diazonium dyes; nitro dyes; quinone imine dyes; tetrazolium dyes; thiazole dyes; perylene dyes, perinone dyes; bis-benzoxazolylthiophene (BBOT); and xanthene dyes; fluorophores such as anti-stokes shift dyes which absorb in the near infrared wavelength and emit in the visible wavelength, or the like; luminescent dyes such as 5-amino-9-diethyliminobenzo(a)phenoxazonium perchlorate; 7-amino-4-methylcarbostyryl; 7-amino-4-methylcoumarin; 3-(2-benzimidazolyl)-7-N,N-diethylaminocoumarin; 3-(2-benzothiazolyl)-7-diethylaminocoumarin; 2-(4-biphenylyl)-5-(4-t-butylphenyl)-1,3,4-oxadiazole; 2-(4-biphenyl)-6-phenylbenzoxazole-1,3;2,5-Bis-(4-biphenylyl)-1,3,4-oxadiazole; 2,5-bis-(4-biphenylyl)-oxazole; 4,4-bis-(2-butyloctyloxy)-p-quaterphenyl; p-bis(o-methylstyryl)-benzene; 5,9-diaminobenzo(a)phenoxazonium perchlorate; 4-dicyanomethylene-2-methyl-6-(p-dimethylaminostyryl)-4H-pyran; 1,1-diethyl-2,2-carbocyanine iodide; 3,3-diethyl-4,4,5,5-dibenzothiatricarbocyanine iodide; 7-diethylamino-4-methylcoumarin; 7-diethylamino-4-trifluoromethylcoumarin; 2,2-dimethyl-p-quaterphenyl; 2,2-dimethyl-p-terphenyl; 7-ethylamino-6-methyl-4-trifluoromethylcoumarin; 7-ethylamino-4-trifluoromethylcoumarin; nile red; rhodamine 700; oxazine 750; rhodamine 800; IR 125; IR 144; IR 140; IR 132; IR 26; IR 5; diphenylhexatriene; diphenylbutadiene; tetraphenylbutadiene; naphthalene; anthracene; 9,10-diphenylanthracene; pyrene; chrysene; rubrene; coronene; phenanthrene or the like, or combinations including at least one of the foregoing dyes.

Suitable colorants may include, for example titanium dioxide, anthraquinones, perylenes, perinones, indanthrones, quinacridones, xanthenes, oxazines, oxazolines, thioxanthenes, indigoids, thioindigoids, naphthalimides, cyanines, xanthenes, methines, lactones, coumarins, bis-benzoxazolylthiophene (BBOT), napthalenetetracarboxylic derivatives, monoazo and disazo pigments, triarylmethanes, aminoketones, bis(styryl)biphenyl derivatives, and the like, as well as combinations including at least one of the foregoing colorants.

In certain embodiments, the polyolefin-based color masterbatch can have a particular level of saturation, or color loading. The color loading of the polyolefin-based color masterbatch can be from 10 wt. % to 70 wt. % of the total weight of the polyolefin-based color masterbatch, or from 15 wt. % to 70 wt. %, or from 20 wt. % to 70 wt. %, or from 25 wt. % to 70 wt. %, or from 30 wt. % to 70 wt. %, or from 35 wt. % to 70 wt. %, or from 40 wt. % to 70 wt. %, or from 45 wt. % to 70 wt. %, or from 50 wt. % to 70 wt. %, or from 55 wt. % to 70 wt. %, or even from 60 wt. % to 70 wt. % of the total weight of the polyolefin-based color masterbatch. In further embodiments, the color loading of the polyolefin-based color masterbatch can be from about 10 wt. % to about 70 wt. % of the total weight of the polyolefin-based color masterbatch, or from about 15 wt. % to about 70 wt. %, or from about 20 wt. % to about 70 wt. %, or from about 25 wt. % to about 70 wt. %, or from about 30 wt. % to about 70 wt. %, or from about 35 wt. % to about 70 wt. %, or from about 40 wt. % to about 70 wt. %, or from about 45 wt. % to about 70 wt. %, or from about 50 wt. % to about 70 wt. %, or from about 55 wt. % to about 70 wt. %, or even from about 60 wt. % to about 70 wt. % of the total weight of the polyolefin-based color masterbatch. In one particular example, the color masterbatch can include 40 percent by weight, or about 40 percent by weight, carbon black as a colorant and 60% by weight, or about 60% by weight polyethylene as the carrier resin. Generally, if the color loading is high in the masterbatch, then less masterbatch is required to provide the same color performance, and any negative effects of the carrier resin on the properties of the resin composite can be minimized. Excessively high color loading in the masterbatch, however, increases costs and introduces masterbatch feed and color dispersion challenges.

The color masterbatch of the present disclosure includes a polyolefin carrier resin. Generally, the carrier resin can be selected to provide good dispersion of the colorant throughout the carrier resin. In various examples, the polyolefin based color masterbatch can include a polyethylene or a polypropylene carrier resin, although other polyolefin-based carrier resins could certainly be used.

The polyolefin-based masterbatch can be compounded with the polyamide base resin and glass fiber. In some embodiments dye and/or pigment employed in the color concentrate is free of chlorine, bromine, and fluorine. As appreciated by one of skill in the art, the color of the composition prior to the addition of color concentrate may impact the final color achieved and in some cases it may be advantageous to employ a bleaching agent and/or color stabilization agents. Bleaching agents and color stabilization agents are known in the art and are commercially available.

As noted above, in certain examples the resin composite disclosed herein includes from 0.1 wt. % to 10 wt. %, about 0.1 wt. % to about 10 wt. %, of a polyolefin-based color masterbatch. In other examples, the resin composite includes from 0.1 wt. % to 8 wt. % of a polyolefin-based color masterbatch, or from 0.1 wt. % to 5 wt. % of a polyolefin-based color masterbatch, or from 0.1 wt. % to 2 wt. % of a polyolefin-based color masterbatch, or from 0.1 wt. % to 1 wt. % of a polyolefin-based color masterbatch, or even from 0.1 wt. % to 0.5 wt. % of a polyolefin-based color masterbatch. In yet further examples, the resin composite includes from about 0.1 wt. % to about 8 wt. % of a polyolefin-based color masterbatch, or from about 0.1 wt. % to about 5 wt. % of a polyolefin-based color masterbatch, or from about 0.1 wt. % to about 2 wt. % of a polyolefin-based color masterbatch, or from about 0.1 wt. % to about 1 wt. % of a polyolefin-based color masterbatch, or even from about 0.1 wt. % to about 0.5 wt. % of a polyolefin-based color masterbatch.

### Compatibilizer

As discussed, the incorporation of a polyolefin-based color masterbatch can diminish certain physical properties of the polyamide-based composite resin. As such, resin composites according to the present disclosure include a compatibilizer. As used herein, compatibilizer, compatibilizing agent, or other derivatives, can refer to polyfunctional compounds which can interact with the polyolefin-based color masterbatch, the polyamide resin, or both. The compatibilizer may be added to improve the miscibility between the polyamide base resin and the respective glass fiber and polyolefin-based color masterbatch. The interaction may be chemical (e.g., grafting) and/or physical (e.g., affecting the surface characteristics of the dispersed resin phases). Exemplary compatibilizers can include liquid diene polymers, epoxy compounds, oxidized polyolefin wax, quinones, organosilane compounds, polyfunctional compounds, functionalized polyolefins, and combinations comprising at least one of the foregoing. Compatibilizers are further described in U.S. Pat. Nos. 5,132,365 and 6,593,411 as well as U.S. Patent Application No. 2003/0166762.

The compatibilizer of the present disclosure can include a modified or “functionalized” polyolefin. This refers to the presence of functional groups on the primary chain of the polyolefin. In an example, the compatibilizer of the disclosed resin composite can be copolymerized or grafted with a saturated or unsaturated monomer comprising epoxy, carboxyl, or an acid anhydride group. As such, the compatibilizer may comprise a maleated polyolefin.

The maleated polyolefin may feature structural characteristics that facilitate the specific blend of the polyamide base resin, glass fiber, and polyolefin-based color masterbatch disclosed herein. Generally, a maleated polyolefin polymer may comprise two functional domains: a polyolefin and a maleic anhydride domain. One skilled in the art might appreciate that the polyolefin domain, which may include, for example, a high density polyethylene HDPE or polypropylene, is able to interact with the non-polar polyolefin of the resin composite. The maleic anhydride domain is able to interact with the polar polyamide base resin. These maleated polyolefins are generally prepared by grafting maleic anhydride onto the polymer backbone of the desired polyolefin domain. Typically, the maleic anhydride may be grafted such that the resulting maleic anhydride functionalized polyolefin includes from 1 wt. % to 6 wt. %, or from about 1 wt. % to 6 wt. %, maleic anhydride. In some examples, the resulting maleic anhydride functionalized polyolefin may include from 0.5 wt. % to 2 wt. %, or from about 0.5 wt. % to about 2 wt. % maleic anhydride. As a further example, and not to be limiting, the maleated polyolefin can include a maleic anhydride-grafted polyethylene copolymer. In yet further examples, the compatibilizer may include a maleic anhydride-grafted polyalphaolefin. Maleic anhydride-grafted polyolefins useful in the present disclosure may include maleic anhydride-grafted ethylene-propylene, maleic anhydride-grafted ethylene-propylene-diene terpolymer (MAH-g-EPDM), maleic anhydride-grafted ethylene-octene copolymer (MAH-g-POE), maleic anhydride-grafted ethylene-butene copolymer (MAH-g-EBR), maleic anhydride-grafted ethylene-acrylic ester copolymer (MAH-g-EAE) or some combination thereof. In a specific example, the maleated polyolefin can comprise a maleated ethylene propylene copolymer having a flowrate of 22 grams per 10 minutes (g/10 min) when tested in accordance with ASTM D1238 and ISO 1133 at 230° C. and 10 kilogram (kg).

As noted above, in certain examples the resin composite disclosed herein includes from 0.1 wt. % to 20 wt. %, or from about 0.1 wt. % to about 20 wt. % of a compatibilizer. In other examples, the resin composite includes from 0.1 wt. % to 15 wt. % of a compatibilizer, or from 0.1 wt. % to 10 wt. % of a compatibilizer, or from 0.1 wt. % to 5 wt. % of a compatibilizer, or from 0.1 wt. % to 2 wt. % of a compatibilizer, or even from 0.1 wt. % to 1 wt. % of a compatibilizer. In some examples, the resin composite includes from about 0.1 wt. % to about 15 wt. % of a compatibilizer, or from about 0.1 wt. % to about 10 wt. % of a compatibilizer, or from about 0.1 wt. % to about 5 wt. % of a compatibilizer, or from about 0.1 wt. % to about 2 wt. % of a compatibilizer, or even from about 0.1 wt. % to about 1 wt. % of a compatibilizer

### Additives

The resin composite may optionally further include one or more other additives. The one or more additives may be included in the resin composites to impart one or more selected characteristics to the resin composites and any molded article made therefrom. Suitable additives can include, heat stabilizers, process stabilizers, antioxidants, light stabilizers, plasticizers, antistatic agents, mold releasing agents, ultraviolet (UV) absorbers, lubricants, pigments, dyes, colorants, flow promoters, flame retardants, or a combination of one or more of the foregoing additives. According to one embodiment, the one or more additives may constitute from 0.1 wt. % to 40 wt. %, or from about 0.1 wt. % to about 40 wt. %, of the resin composite such that according to one embodiment, the one or more additives constitute at least 0.1 wt. %, or at least about 0.1 wt. %, of the resin composite, and according to another embodiment the one or more additives constitute no greater than 40 wt. %, or no greater than about 40 wt. %, of the resin composite.

Suitable heat stabilizers include, for example, organo phosphites such as triphenyl phosphite, tris-(2,6-dimethylphenyl)phosphite, tris-(mixed mono- and di-nonylphenyl)phosphite or the like; phosphonates such as dimethylbenzene phosphonate or the like, phosphates such as trimethyl phosphate, or the like, or combinations including at least one of the foregoing heat stabilizers. Heat stabilizers are generally used in amounts of about 0.1 wt. % to about 0.5 wt. % of the resin composite, but could be used in other amounts.

Suitable antioxidants include, for example, organophosphites such as tris(nonyl phenyl)phosphite, tris(2,4-di-t-butylphenyl)phosphite, bis(2,4-di-t-butylphenyl)pentaerythritol diphosphite, distearyl pentaerythritol diphosphite or the like; alkylated monophenols or polyphenols; alkylated reaction products of polyphenols with dienes, such as tetrakis[methylene(3,5-di-tert-butyl-4-hydroxyhydrocinnamate)]methane, or the like; butylated reaction products of para-cresol or dicyclopentadiene; alkylated hydroquinones; hydroxylated thiodiphenyl ethers; alkylidene-bisphenols; benzyl compounds; esters of beta-(3,5-di-tert-butyl-4-hydroxyphenyl)-propionic acid with monohydric or polyhydric alcohols; esters of beta-(5-tert-butyl-4-hydroxy-3-methylphenyl)-propionic acid with monohydric or polyhydric alcohols; esters of thioalkyl or thioaryl compounds such as distearylthiopropionate, dilaurylthiopropionate, ditridecylthiodipropionate, octadecyl-3-(3,5-di-tert-butyl-4-hydroxyphenyl)propionate, pentaerythrityl-tetrakis[3-(3,5-di-tert-butyl-4-hydroxyphenyl)propionate or the like; amides of beta-(3,5-di-tert-butyl-4-hydroxyphenyl)-propionic acid or the like, or combinations including at least one of the foregoing antioxidants. Antioxidants are generally used in amounts of 0.1 wt. % to 0.5 wt. %, or about 0.1 wt. % to about 0.5 wt. %, of the resin composite, but could be used in other amounts.

Suitable light stabilizers include, for example, benzotriazoles such as 2-(2-hydroxy-5-methylphenyl)benzotriazole, 2-(2-hydroxy-5-tert-octylphenyl)-benzotriazole and 2-hydroxy-4-n-octoxy benzophenone or the like or combinations including at least one of the foregoing light stabilizers. Light stabilizers are generally used in amounts of 0.1 wt. % to 1.0 wt. %, or about 0.1 wt. % to about 1.0 wt. %, of the resin composite, but could be used in other amounts.

Suitable plasticizers include, for example, phthalic acid esters such as dioctyl-4,5-epoxy-hexahydrophthalate, tris-(octoxycarbonylethyl)isocyanurate, tristearin, epoxidized soybean oil or the like, or combinations including at least one of the foregoing plasticizers. Plasticizers are generally used in amounts of 0.5 wt. % to 3.0 wt. %, or about 0.5 wt. % to about 3.0 wt. %, of the resin composite, but could be used in other amounts.

Suitable mold releasing agents include for example, metal stearate, stearyl stearate, pentaerythritol tetrastearate, beeswax, montan wax, paraffin wax, or the like, or combinations including at least one of the foregoing mold release agents. Mold releasing agents are generally used in amounts of 0.1 wt. % to 1.0 wt. %, or about 0.1 wt. % to about 1.0 wt. %, of the resin composite, but could be used in other amounts.

Suitable UV absorbers include for example, hydroxybenzophenones; hydroxybenzotriazoles; hydroxybenzotriazines; cyanoacrylates; oxanilides; benzoxazinones; 2-(2H-benzotriazol-2-yl)-4-(1,1,3,3-tetramethylbutyl)-phenol (CYASORBT™ 5411); 2-hydroxy-4-n-octyloxybenzophenone (CYASORB™ 531); 2-[4,6-bis(2,4-dimethylphenyl)-1,3,5-triazin-2-yl]-5-(octyloxy)-phenol (CYASORB™ 1164); 2,2′-(1,4-phenylene)bis(4H-3,1-benzoxazin-4-one) (CYASORB™ UV-3638); 1,3-bis[(2-cyano-3,3-diphenylacryloyl)oxy]-2,2-bis[[(2-cyano-3,3-diphenylacryloyl)oxy]methyl]propane (UVINUL™ 3030); 2,2′-(1,4-phenylene)bis(4H-3,1-benzoxazin-4-one); 1,3-bis[(2-cyano-3,3-diphenylacryloyl)oxy]-2,2-bis[[(2-cyano-3,3-diphenylacryloyl)oxy]methyl]propane; nano-size inorganic materials such as titanium oxide, cerium oxide, and zinc oxide, all with particle size less than 100 nanometers; or the like, or combinations including at least one of the foregoing UV absorbers. UV absorbers are generally used in amounts of 0.1 wt. % to 3.0 wt. %, or about 0.1 wt. % to about 3.0 wt. % of the resin composite, but could be used in other amounts.

Suitable blowing agents include for example, low boiling halohydrocarbons and those that generate carbon dioxide; blowing agents that are solid at room temperature and when heated to temperatures higher than their decomposition temperature, generate gases such as nitrogen, carbon dioxide, ammonia gas, such as azodicarbonamide, metal salts of azodicarbonamide, 4,4′ oxybis(benzenesulfonylhydrazide), sodium bicarbonate, ammonium carbonate, or the like, or combinations including at least one of the foregoing blowing agents. Blowing agents are generally used in amounts of 1.0 wt. % to 20 wt. %, or about 1.0 wt. % to about 20 wt. %, of the resin composite, but could be used in other amounts.

Suitable flame retardants include, but are not limited to, halogenated flame retardants, like tetrabromo bisphenol A oligomers such as BC58 and BC52, brominated polystyrene or poly(dibromo-styrene), brominated epoxies, decabromodiphenyleneoxide, pentabrombenzyl acrylate monomer, pentabromobenzyl acrylate polymer, ethylene-bis(tetrabromophthalimide, bis(pentabromobenzyl)ethane, metal hydroxides like Mg(OH)₂ and Al(OH)₃, melamine cyanurate, phosphor based flame retardant systems like red phosphorus, melamine polyphosphate, phosphate esters, metal phosphinates, ammonium polyphosphates, expandable graphites, sodium or potassium perfluorobutane sulfate, sodium or potassium perfluorooctane sulfate, sodium or potassium diphenylsulfone sulfonate and sodium- or potassium-2,4,6-trichlorobenzoate and N-(p-tolylsulfonyl)-p-toluenesulfimide potassium salt, N-(N′-benzylaminocarbonyl) sulfanylimide potassium salt, or a combination containing at least one of the foregoing. Flame retardants are generally used in amounts of about 1.0 wt. % to about 40 wt. % of the resin composite, but could be used in other amounts.

### Methods

In many aspects, the resin composite disclosed herein may be prepared according to a variety of methods. For example, the resin composite may be blended, compounded, or otherwise combined with the aforementioned ingredients by a variety of methods involving intimate admixing of the materials with any additional additives desired in the formulation. Because of the availability of melt blending equipment in commercial polymer processing facilities, melt processing methods can be used. In various further aspects, the equipment used in such melt processing methods can include, but is not limited to, the following: co-rotating and counter-rotating extruders, single screw extruders, co-kneaders, disc-pack processors and various other types of extrusion equipment.

According to one embodiment, the components of the resin composite may first be dry blended together, then fed into an extruder from a single feeder or a multi-feeder. In an alternative embodiment, each component can be separately fed into extruder. For example, the polyamide base resin may be dry blended with any combination of the foregoing mentioned glass fiber(s), compatibilizer(s), and optional additives, and then fed into an extruder from a single feeder or multi-feeder. If the polyamide base resin includes multiple polyamides as described above, the polyamides may first be dry blended separately or may be dry blended with the other components as described above. In another example, the polyamide base resin, glass fiber, compatibilizer and optional additives may be separately fed into an extruder from a single feeder or multi-feeder. In a further example, the glass fibers may be first processed into a master batch, and then fed into the extruder. In yet another example, the polyamide base resin, compatibilizer, additives, glass fiber or any combination or mixture thereof may be fed into an extruder from a throat hopper or a side feeder. As a specific example, the polyolefin-based color masterbatch may be mixed with the polyamide base resin, the compatibilizer, and optional additives before the resulting mixture is introduced into the feed throat hopper of an extruder for compounding. In an alternative example, the polyolefin-based color masterbatch can be mixed with compatibilizer and additives before being introduced into the feed throat hopper or side feeder of an extruder for compounding.

The extruders used in the invention may have a single screw, multiple screws, intermeshing co-rotating or counter rotating screws, non-intermeshing co-rotating or counter rotating screws, reciprocating screws, screws with pins, screws with screens, barrels with pins, rolls, rams, helical rotors, or combinations including at least one of the foregoing. The melt blending of the composites involves the use of shear force, extensional force, compressive force, ultrasonic energy, electromagnetic energy, thermal energy or combinations including at least one of the foregoing forces or forms of energy. In an embodiment, the extruder is a twin-screw extruder. In various further aspects, the composition can be processed in an extruder at temperatures from 180° C. to 315° C., or from about 180° C. to about 315° C., or in some examples from 240° C. to 300° C., or from about 240° C. to about 300° C. during compounding.

The barrel temperature on the extruder during compounding may be set at a temperature or within a temperature range where at least a portion of the resin has reached a temperature greater than or equal to about the melting temperature, if the resin is a semi-crystalline organic polymer, or the flow point (e.g., the glass transition temperature) if the resin is an amorphous resin.

The resin composite may be subject to multiple blending and forming steps if desirable prior to forming the resultant moldable article. For example, the resin composite may first be extruded and formed into pellets. The pellets may then be fed into a molding machine where it may be formed into an article of manufacture of any shape or product as desired. Alternatively, the resin composite can emanate from a single melt blender and subsequently be formed into sheets or strands and then further subjected to post-extrusion processes such as annealing, or uniaxial or biaxial orientation.

Solution blending may also be used to manufacture the resultant moldable article formed from the resin composite. Solution blending may also use additional energy such as shear, compression, ultrasonic vibration, or the like, to promote homogenization of the components of the resin composite.

The present disclosure can include at least the following aspects.

Aspect 1. A resin composite comprising: from 20 wt. % to 90 wt. % of a polyamide base resin; from 8 wt. % to 60 wt. % of glass fiber; from 0.1 wt. % to 10 wt. % of a polyolefin-based color masterbatch; and from 0.1 wt. % to 20 wt. % of a compatibilizer, wherein the resin composite exhibits an Izod impact strength greater than 10% of a substantially similar resin composite in the absence of the compatibilizer when tested in accordance with ASTM D256, the combined weight percent value of all components does not exceed about 100 wt. %, and all weight percent values are based on the total weight of the composition.

Aspect 2. A resin composite comprising of: from about 20 wt. % to about 90 wt. % of a polyamide base resin; from about 8 wt. % to about 60 wt. % of glass fiber; from about 0.1 wt. % to about 10 wt. % of a polyolefin-based color masterbatch; and from about 0.1 wt. % to about 20 wt. % of a compatibilizer, wherein the resin composite exhibits an Izod impact strength greater than 10% of a substantially similar resin composite in the absence of the compatibilizer when tested in accordance with ASTM D256, the combined weight percent value of all components does not exceed about 100 wt. %, and all weight percent values are based on the total weight of the composition.

Aspect 3. A resin composite consisting of: from about 20 wt. % to about 90 wt. % of a polyamide base resin; from about 8 wt. % to about 60 wt. % of glass fiber; from about 0.1 wt. % to about 10 wt. % of a polyolefin-based color masterbatch; and from about 0.1 wt. % to about 20 wt. % of a compatibilizer, wherein the resin composite exhibits an Izod impact strength greater than 10% of a substantially similar resin composite in the absence of the compatibilizer when tested in accordance with ASTM D256, the combined weight percent value of all components does not exceed about 100 wt. %, and all weight percent values are based on the total weight of the composition.

Aspect 4. A resin composite consisting of: from about 20 wt. % to about 90 wt. % of a polyamide base resin; from about 8 wt. % to about 60 wt. % of glass fiber; from about 0.1 wt. % to about 10 wt. % of a polyolefin-based color masterbatch; and from about 0.1 wt. % to about 20 wt. % of a compatibilizer, wherein the resin composite exhibits an Izod impact strength greater than 10% of a substantially similar resin composite in the absence of the compatibilizer when tested in accordance with ASTM D256, the combined weight percent value of all components does not exceed about 100 wt. %, and all weight percent values are based on the total weight of the composition.

Aspect 5. A resin composite consisting essentially of: from about 20 wt. % to about 90 wt. % of a polyamide base resin; from about 8 wt. % to about 60 wt. % of glass fiber; from about 0.1 wt. % to about 10 wt. % of a polyolefin-based color masterbatch; and from about 0.1 wt. % to about 20 wt. % of a compatibilizer, wherein the resin composite exhibits an Izod impact strength greater than 10% of a substantially similar resin composite in the absence of the compatibilizer when tested in accordance with ASTM D256, the combined weight percent value of all components does not exceed about 100 wt. %, and all weight percent values are based on the total weight of the composition.

Aspect 6. A resin composite consisting essentially of: from about 20 wt. % to about 90 wt. % of a polyamide base resin; from about 8 wt. % to about 60 wt. % of glass fiber; from about 0.1 wt. % to about 10 wt. % of a polyolefin-based color masterbatch; and from about 0.1 wt. % to about 20 wt. % of a compatibilizer, wherein the resin composite exhibits an Izod impact strength greater than 10% of a substantially similar resin composite in the absence of the compatibilizer when tested in accordance with ASTM D256, the combined weight percent value of all components does not exceed about 100 wt. %, and all weight percent values are based on the total weight of the composition.

Aspect 7. A resin composite consisting essentially of: from about 20 wt. % to about 90 wt. % of a polyamide base resin; from about 8 wt. % to about 20 wt. % of glass fiber; from about 0.1 wt. % to about 10 wt. % of a polyolefin-based color masterbatch; and from about 0.1 wt. % to about 20 wt. % of a compatibilizer, wherein the resin composite exhibits an Izod impact strength greater than 10% of a substantially similar resin composite in the absence of the compatibilizer when tested in accordance with ASTM D256, the combined weight percent value of all components does not exceed about 100 wt. %, and all weight percent values are based on the total weight of the composition.

Aspect 8. A resin composite consisting essentially of: from about 20 wt. % to about 90 wt. % of a polyamide base resin; from about 8 wt. % to about 15 wt. % of glass fiber; from about 0.1 wt. % to about 10 wt. % of a polyolefin-based color masterbatch; and from about 0.1 wt. % to about 20 wt. % of a compatibilizer, wherein the resin composite exhibits an Izod impact strength greater than 10% of a substantially similar resin composite in the absence of the compatibilizer when tested in accordance with ASTM D256, the combined weight percent value of all components does not exceed about 100 wt. %, and all weight percent values are based on the total weight of the composition.

Aspect 10. A resin composite comprising: from 20 wt. % to 90 wt. % of a polyamide base resin; from 8 wt. % to 60 wt. % of glass fiber; from 0.1 wt. % to 10 wt. % of a polyolefin-based color masterbatch; and from 0.1 wt. % to 20 wt. % of a maleated polyolefin, wherein the resin composite exhibits an Izod impact strength greater than 10% of a substantially similar resin composite in the absence of the maleated polyolefin when tested in accordance with ASTM D256, the combined weight percent value of all components does not exceed about 100 wt. %, and all weight percent values are based on the total weight of the composition.

Aspect 11. A resin composite comprising: from about 20 wt. % to about 90 wt. % of a polyamide base resin; from about 8 wt. % to about 60 wt. % of glass fiber; from about 0.1 wt. % to about 10 wt. % of a polyolefin-based color masterbatch; and from about 0.1 wt. % to about 20 wt. % of a maleated polyolefin, wherein the resin composite exhibits an Izod impact strength greater than 10% of a substantially similar resin composite in the absence of the maleated polyolefin when tested in accordance with ASTM D256, the combined weight percent value of all components does not exceed about 100 wt. %, and all weight percent values are based on the total weight of the composition.

Aspect 12. A resin composite consisting of: from about 20 wt. % to about 90 wt. % of a polyamide base resin; from about 8 wt. % to about 60 wt. % of glass fiber; from about 0.1 wt. % to about 10 wt. % of a polyolefin-based color masterbatch; and from about 0.1 wt. % to about 20 wt. % of a maleated polyolefin, wherein the resin composite exhibits an Izod impact strength greater than 10% of a substantially similar resin composite in the absence of the maleated polyolefin when tested in accordance with ASTM D256, the combined weight percent value of all components does not exceed about 100 wt. %, and all weight percent values are based on the total weight of the composition.

Aspect 13. A resin composite consisting essentially of: from about 20 wt. % to about 90 wt. % of a polyamide base resin; from about 8 wt. % to about 60 wt. % of glass fiber; from about 0.1 wt. % to about 10 wt. % of a polyolefin-based color masterbatch; and from about 0.1 wt. % to about 20 wt. % of a maleated polyolefin, wherein the resin composite exhibits an Izod impact strength greater than 10% of a substantially similar resin composite in the absence of the maleated polyolefin when tested in accordance with ASTM D256, the combined weight percent value of all components does not exceed about 100 wt. %, and all weight percent values are based on the total weight of the composition.

Aspect 14. A resin composite comprising: from about 60 wt. % to about 90 wt. % of a polyamide base resin; from about 8 wt. % to about 60 wt. % of glass fiber; from about 0.1 wt. % to about 10 wt. % of a polyolefin-based color masterbatch; and from about 0.1 wt. % to about 20 wt. % of a maleated polyolefin, wherein the resin composite exhibits an Izod impact strength greater than 10% of a substantially similar resin composite in the absence of the maleated polyolefin when tested in accordance with ASTM D256, the combined weight percent value of all components does not exceed about 100 wt. %, and all weight percent values are based on the total weight of the composition.

Aspect 15. A resin composite comprising: from about 60 wt. % to about 90 wt. % of a polyamide base resin; from about 8 wt. % to about 70 wt. % of glass fiber; from about 0.1 wt. % to about 10 wt. % of a polyolefin-based color masterbatch; and from about 0.1 wt. % to about 20 wt. % of a maleated polyolefin, wherein the resin composite exhibits an Izod impact strength greater than 10% of a substantially similar resin composite in the absence of the maleated polyolefin when tested in accordance with ASTM D256, the combined weight percent value of all components does not exceed about 100 wt. %, and all weight percent values are based on the total weight of the composition.

Aspect 16. A resin composite comprising: from about 20 wt. % to about 90 wt. % of a polyamide base resin; from about 8 wt. % to about 70 wt. % of glass fiber; from about 0.1 wt. % to about 3 wt. % of a polyolefin-based color masterbatch; and from about 0.1 wt. % to about 20 wt. % of a maleated polyolefin, wherein the resin composite exhibits an Izod impact strength greater than 10% of a substantially similar resin composite in the absence of the maleated polyolefin when tested in accordance with ASTM D256, the combined weight percent value of all components does not exceed about 100 wt. %, and all weight percent values are based on the total weight of the composition.

Aspect 17. A resin composite comprising: from about 20 wt. % to about 90 wt. % of a polyamide base resin; from about 8 wt. % to about 70 wt. % of glass fiber; from about 0.1 wt. % to about 10 wt. % of a polyolefin-based color masterbatch; and from about 0.1 wt. % to about 5 wt. % of a maleated polyolefin, wherein the resin composite exhibits an Izod impact strength greater than 10% of a substantially similar resin composite in the absence of the maleated polyolefin when tested in accordance with ASTM D256, the combined weight percent value of all components does not exceed about 100 wt. %, and all weight percent values are based on the total weight of the composition.

Aspect 18. A resin composite comprising: from about 20 wt. % to about 90 wt. % of a polyamide base resin; from about 8 wt. % to about 70 wt. % of glass fiber; from about 0.1 wt. % to about 10 wt. % of a polyolefin-based color masterbatch; and from about 0.1 wt. % to about 3 wt. % of a maleated polyolefin, wherein the resin composite exhibits an Izod impact strength greater than 10% of a substantially similar resin composite in the absence of the maleated polyolefin when tested in accordance with ASTM D256, the combined weight percent value of all components does not exceed about 100 wt. %, and all weight percent values are based on the total weight of the composition.

Aspect 19. The resin composite of any of the preceding aspects, wherein the polyamide base resin comprises polycaprolactam, polyhexamethylene adipamide, Polyhexamethylene sebacamide, polyamide of hexamethylene diamine and n-dodecanedioc acid, polyundecanolactam, polydodecanolactam, polypthalamide, Polyhexamethylene terepthalamide, polyamide of hexamethylenediamine and terephthalic acid, or a combination thereof.

Aspect 20. The resin composite of any of the preceding aspects, wherein the polyamide base resin comprises a polyamide having an intrinsic viscosity of from about 2 to about 4.

Aspect 21. The resin composite of any of the preceding aspects, wherein the glass fiber is E-glass fiber, S-glass fiber, R-glass fiber, or a combination thereof.

Aspect 22. The resin composite of any of the preceding aspects, wherein the glass fiber has a round or a flat cross-section.

Aspect 23. The resin composite of any of the preceding aspects, wherein the glass fiber comprises a silane or metallic surface treatment.

Aspect 24. The resin composite of any of the preceding aspects, wherein the polyolefin-based color masterbatch comprises a polyethylene or a polypropylene carrier resin.

Aspect 25. The resin composite of any of the preceding aspects, wherein the polyolefin-based color masterbatch comprises a low-density polyethylene carrier resin.

Aspect 26. The resin composite of any of the preceding aspects, wherein the polyolefin-based color masterbatch has a colorant loading of from about 10 wt. % to about 70 wt. % of the total weight of the polyolefin-based color masterbatch.

Aspect 27. The resin composite of aspect 1, wherein the compatibilizer comprises a maleated polyolefin.

Aspect 28. The resin composite of any of aspects 2 to 11, wherein the maleated polyolefin comprises a maleated ethylene-propylene copolymer, maleic anhydride-grafted polyethylene copolymer, maleic anhydride-grafted ethylene-propylene-diene monomer, or a maleic anhydride-grafted polyalphaolefin, or a combination thereof.

Aspect 29. The resin composite of any of aspects 2 to 12, wherein the maleated polyolefin comprises a high density polyethylene.

Aspect 30. The resin composite of any of aspects 2 to 13, wherein the maleated polyolefin comprises a maleated ethylene propylene copolymer having a flowrate of 22 g/10 minutes when tested in accordance with ASTM D1238 and ISO 1133 at 230° C. and 10 kg.

Aspect 31. The resin composite of any of the preceding aspects, wherein the resin composite comprises an additive.

Aspect 32. The resin composite of aspect 15, wherein the additive comprises one or more of flow promoters, de-molding agents, a thermal stabilizer, light stabilizer, an ultraviolet absorber, heat stabilizers, process stabilizers, antioxidants, plasticizers, antistatic agents, mold releasing agents, lubricants, flame retardants, or a combination thereof.

Aspect 33. An article formed from the resin composite of any of the preceding aspects.

Aspect 34. A method comprising: forming a thermoplastic composition comprising: from about 20 wt. % to about 90 wt. % of a polyamide base resin; from about 8 wt. % to about 60 wt. % of glass fiber; from about 0.1 wt. % to about 10 wt. % of a polyolefin based color masterbatch; and from about 0.1 wt. % to about 20 wt. % of a compatibilizer, wherein the resin composite exhibits an Izod impact strength greater than 10% of a substantially similar resin composite in the absence of the maleic anhydride-grafted polyolefin when tested in accordance with ASTM D256, the combined weight percent value of all components does not exceed about 100 wt. %, and all weight percent values are based on the total weight of the composition.

### EXAMPLES

Detailed embodiments of the present disclosure are disclosed herein; it is to be understood that the disclosed embodiments are merely exemplary of the disclosure that may be embodied in various forms. Therefore, specific structural and functional details disclosed herein are not to be interpreted as limits, but merely as a basis for teaching one skilled in the art to employ the present disclosure. The specific examples below will enable the disclosure to be better understood. However, they are given merely by way of guidance and do not imply any limitation.

The following examples are provided to illustrate the compositions, processes, and properties of the present disclosure. The examples are merely illustrative and are not intended to limit the disclosure to the materials, conditions, or process parameters set forth therein.

The compositions as set forth in the Examples below were prepared from the components presented in Table 1.

TABLE 1
Chemical description and sources.

| Component | Chemical description | Source |
|---|---|---|
| PA1 | PA66 Regular MV; Medium viscosity Nylon 66 | Nilit |
| | (polyamide PA66) [CAS: 32131-17-2] | |
| PA2 | PA66 Regular HV High viscosity Nylon 66 | BASF |
| | (polyamide PA66), Ultramid ™ A34 01 Natural | |
| | [CAS: 32131-17-2] | |
| PA3 | PL-44 CONC. PA6 [Ultramid ™ B27 from BASF, | SABIC |
| | CAS: 25038-54-4] and PDMS [(30K/SDR from | |
| | Momentive), CAS: 31900-57-9] master batch with | |
| | 80/20 weight ratio | |
| GF | PPG 3540 1/8″ (inch); Glass Fiber (GF) [CAS: | PPG |
| | 65997-17-3] | |
| MB | R19470; Ampacet ™ 19470, Carbon black [CAS: | AMPACET |
| | 1333-86-4]/polyethylene [CAS: 9002-88-4] | CORP |
| | masterbatch with 40/60 weight ratio, | |
| COMP1 | Exxelor ™ 1801; Maleic anhydride grafted EP | Exxon Mobil |
| | (Ethylene-Propylene) copolymer, MFR 9 (g/10 min | |
| | (grams per 10 minutes) (230° C. (degrees Celsius)/10 kg | |
| | (kilogram)), [CAS: 31069-12-2] | |
| COMP2 | Exxelor ™ 1803; Maleic anhydride grafted EP | Exxon Mobil |
| | (Ethylene-Propylene) copolymer, MFR 22 | |
| | (g/10 min) (230° C./10 kg), [CAS: 31069-12-2] | |
| COMP3 | Polybond ™ 3009; Maleic anhydride-grafted | Crompton |
| | Polyethylene [CAS: 1309-42-8] | |

Formulations were prepared by extruding the pre-blended components using a twin extruder. The polyamide resins PA1, PA2, and/or PA3 were first dry blended and combined with the indicated glass fibers and additives. The resin composite was melt-kneaded and extruded. The extrudate was cooled using a water bath prior to pelletizing. Samples were prepared using a WP ZSK26 MC with L/D of 40 co-rotating twin screw extruder with the compounding settings set forth in Table 2.

TABLE 2
Compounding settings.

| | |
|---|---|
| Parameters | UOM |

| | | |
|---|---|---|
| Compounder Type | NONE | WP ZSK26 MC |
| Barrel Size | mm | 1028 |
| Screw Design | NONE | S-2 |
| Die | mm | 425 |
| Zone 1 Temp | ° C. | 50 |
| Zone 2 Temp | ° C. | 200 |
| Zone 3 Temp | ° C. | 260 |
| Zone 4 Temp | ° C. | 260 |
| Zone 5 Temp | ° C. | 260 |
| Zone 6 Temp | ° C. | 260 |
| Zone 7 Temp | ° C. | 260 |
| Zone 8 Temp | ° C. | 260 |
| Zone 9 Temp | ° C. | 260 |
| Zone 10 Temp | ° C. | 260 |
| Die Temp | ° C. | 280 |
| Screw speed | rpm | 350 |
| Throughput | kg/hr | 27 |
| Torque | NONE | 60-80 |
| Vacuum | MPa | −0.08 |
| Side Feeder 1 speed | rpm | No |
| Side Feeder 2 speed | rpm | 300 |
| Side Feeder 1 | NONE | barrel 5 |
| Side Feeder 2 | NONE | barrel 7 |
| Melt temperature | ° C. | 260-270 |

The pellets obtained from extrusion were then injection molded using 150 T injection molding machine at a melt temperature of 280° C. and a mold temperature of 80° C. The injection molding parameters are set forth in Table 3.

TABLE 3
Injection molding settings.

| | |
|---|---|
| Parameters | UOM |

| | | |
|---|---|---|
| Cnd: Pre-drying | Hour | 4 |
| time | | |
| Cnd: Pre-drying | ° C. | 85 |
| temp | | |
| Hopper temp | ° C. | 50 |
| Zone 1 temp | ° C. | 260 |
| Zone 2 temp | ° C. | 270 |
| Zone 3 temp | ° C. | 280 |
| Nozzle temp | ° C. | 270 |
| Mold temp | ° C. | 80 |
| Screw speed | Revolutions | 60 |
| | per minute | |
| | (rpm) | |
| Back pressure | (Kilogram | 30 |
| | force per | |
| | square | |
| | centimeter) | |
| | kgf/cm² | |
| Cooling time | Seconds (s) | 15 |
| Injection speed | Millimeters | 50 |
| | per second | |
| | (mm/s) | |
| Holding pressure | kgf/cm² | 250 |
| Max. Injection | kgf/cm² | 600 |
| pressure | | |

Molded samples were then tested in accordance with the standards presented below.

The notched Izod impact (“NII”) test was carried out on 63.5 mm (millimeter) by 12.7 mm by 3.2 mm molded samples (bars) according to ASTM D256 (2010) at 23° C. The unnotched Izod impact (“UII”) test was carried out on 63.5 mm (millimeter) by 12.7 mm by 3.2 mm bars according to ASTM D4812 (2011) at 23° C. Data is presented as an average and units are presented in J/m (Joules per meter).

Flexural properties (modulus and strength) were measured using 127 millimeter (mm) by 12.7 mm by 3.2 mm bars in accordance with ASTM 790 (2010). Flexural stress at break (“FS”) and flexural modulus (“FM”) are reported as an average in units of MPa (megapascal).

Tensile properties were measured using a Tensile Type 1 bar (57 mm by 13 mm by 3.2 mm by 176 mm) in accordance with ASTM D638 (2014) using sample bars prepared in accordance with a Tensile Type 1 bar (57 mm by 13 mm by 3.2 mm by 176 mm). Tensile strength for either at break or at yield is reported as an average in units of MPa.

Heat deflection temperature was determined per ASTM D648 (2007) with flatwise specimen orientation with specimen dimensions of 127 mm by 12.7 mm by 3.2 mm at 1.82 MPa. Data are presented as an average in units of ° C.

Melt volume-flow rate (“MVR”) was determined according to standard ASTM D1238 (2007) under the following test conditions: 275° C./2.16 kg/360 second (s) dwell time or 300° C./1.2 kg load/360 s dwell time. Data below are provided as an average for MVR in cubic centimeters per 10 minutes (cm³/10 min).

Specific gravity was obtained according to ASTM D792 (2013).

The formulation and composite performance testing for the formulations comprising the medium viscosity polyamide resin nylon 6,6 (PA1), silized nylon 6 (PA3) carbon black color masterbatch (MB), glass fiber (GF), and maleic anhydride-grafted polyolefins (COMP1-COMP3) are labeled Example 1, Example 2, and Example 3 (E1-E3) in Table 4 below. Comparative formulations (CS1-CS3) were also prepared. Comparative sample 1 contains no color masterbatch. Comparative sample 2 contains color masterbatch, but no maleic anhydride-grafted polyolefin. Comparative sample 3 similarly has no maleic anhydride-grafted polyolefin, but includes the color masterbatch at a higher loading than that of CS2 (i.e., 0.5 wt. % MB for CS2; 1 wt. % MB for CS3). Inventive Examples 1-3 differ in the type of maleic anhydride-grafted polyolefin.

TABLE 4
Medium viscosity polyamide resin composite with glass fiber and color masterbatch.

| | Unit | CS1 | CS2 | CS3 | E1 | E2 | E3 |
|---|---|---|---|---|---|---|---|
| Item Description | | | | | | | |
| PA1 | % | 78 | 77.6 | 77.2 | 76.2 | 76.2 | 76.2 |
| PA3 | % | 10 | 10 | 9.9 | 9.9 | 9.9 | 9.9 |
| MB | % | 0 | 0.5 | 1 | 1 | 1 | 1 |
| COMP1 | % | 0 | 0 | 0 | 0 | 1 | 0 |
| COMP2 | % | 0 | 0 | 0 | 0 | 0 | 1 |
| COMP3 | % | 0 | 0 | 0 | 1 | 0 | 0 |
| GF | % | 12 | 11.9 | 11.9 | 11.9 | 11.9 | 11.9 |
| Formulation Total | | 100 | 100 | 100 | 100 | 100 | 100 |
| Test Description | | | | | | | |
| Avg. NII Strength- | J/m | 44.6 | 31.7 | 28.7 | 28.5 | 33.1 | 32.5 |
| Avg. UII Strength | J/m | 411 | 324 | 300 | 375 | 392 | 333 |
| Percent difference of UII to | % | — | — | — | +25 | +30.7 | +11 |
| UII CS3 | | | | | | | |
| Avg. Modulus of Elasticity | MPa | 4760.2 | 4800.8 | 4668.2 | 4336 | 4569.8 | 4702.2 |
| Avg. Stress at break | MPa | 94.6 | 88.3 | 85.4 | 82.3 | 86.5 | 85.7 |
| Avg. Elongation at break | % | 2.57 | 2.3 | 2.29 | 2.46 | 2.62 | 2.41 |
| Avg. Flexural Modulus | MPa | 3690 | 3790 | 3660 | 3350 | 3510 | 3520 |
| Avg. Flexural Stress at | MPa | 145 | 128 | 130 | 122 | 130 | 128 |
| break | | | | | | | |
| Avg. Deflection temp. | ° C. | 234 | 233 | 231 | 210 | 222 | 225 |
| Avg. Specific Gravity | — | 1.215 | 1.218 | 1.216 | 1.213 | 1.215 | 1.215 |
| Avg. MVR | cm³/10 min | 48.6 | 41.7 | 42.5 | 81.9 | 39.6 | 47.2 |
| (275° C./2.16 kg/360 s) | | | | | | | |

Data for CS1-CS3 support the assertions above that the addition of color masterbatch to the resin can diminish certain mechanical properties. The notched and unnotched impact strengths decreased as the amount of carbon black masterbatch was increased. As shown, for the inclusion of 0.5 wt. % MB, the notched Izod decreased from 44.6 J/m in CS1 to 31.7 J/m in CS2. The trend continued for CS3 where the notched Izod had decreased to 28.7 J/m. However, with the addition of the maleic anhydride-grafted polyolefin compatibilizers (COMP1-COMP3), the notched and unnotched impact strength values for E1, E2, and E3 showed an increasing trend (28.5 J/m, 33.1 J/m, and 32.5 J/m for notched Izod; 375 J/m, 392 J/m, and 333 J/m for unnotched Izod). Of the compatibilizers, the maleic anhydride-grafted ethylene-propylene with an MFR of 9 grams per 10 minutes (g/10 min) (COMP1) provided the largest percent difference in unnotched Izod values when compared to CS3. Introduction of the compatibilizers provided the percent elongation at break at a higher value while also maintaining the tensile modulus and tensile stress.

Table 5 presents a second series of formulations to exhibit the effect of the maleic anhydride-grafted polyolefin with resin composites including the high viscosity polyamide resin PA2 instead of the medium viscosity polyamide PA1. Comparative sample 4 (CS4) includes the high viscosity polyamide resin (PA2), the silized nylon 6 (PA3), and glass fiber (GF). Similar to the data obtained for the composite resin including the medium viscosity polyamide, the introduction of the color masterbatch decreases the notched and unnotched Izod impact strength of the composite resin (e.g., NII strength of CS4 was 39.7 J/m; NII strength of CS5 was 34.4 J/m). Further, as shown in E4 and E5 the inclusion of the maleic anhydride-grafted polyolefin compatibilizer again increased the notched and unnotched impact of the resin composite compared to the composite in the absence of the compatibilizer (i.e., the percent difference of UII to UII CS5 for E4 and E5 was 33.1% and 11.7%, respectively). Again, the maleic anhydride-grafted ethylene propylene with an MFR 9 g/min (COMP1) provided the larger percent difference of the compatibilizers.

TABLE 5
High viscosity polyamide resin composite with glass fiber and color masterbatch.

| | Unit | CS4 | CS5 | E4 | E5 |
|---|---|---|---|---|---|
| Item Description | | | | | |
| PA2 | % | 78 | 77.2 | 76.2 | 76.2 |
| PA3 | % | 10 | 9.9 | 9.9 | 9.9 |
| MB | % | 0 | 1 | 1 | 1 |
| COMP1 | % | 0 | 0 | 1 | 0 |
| COMP2 | % | 0 | 0 | 0 | 1 |
| GF | % | 12 | 11.9 | 11.9 | 11.9 |
| Formulation total | — | 100 | 100 | 100 | 100 |
| Test Description | | | | | |
| Avg. NII Strength- | J/m | 39.7 | 34.4 | 41.8 | 35.5 |
| Avg. UII Strength | J/m | 444 | 420 | 559 | 469 |
| Percent difference of UII to UII | % | — | — | +33.1 | +11.7 |
| CS5 | | | | | |
| Avg. Modulus of Elasticity | MPa | 4722.8 | 5107 | 4942.4 | 5012.4 |
| Avg. Stress at break | MPa | 84.3 | 96.8 | 97.3 | 94.7 |
| Avg. Elongation at break | % | 6.27 | 2.46 | 2.85 | 2.55 |
| Avg. Flexural Modulus | MPa | 3490 | 4100 | 3760 | 3760 |
| Avg. Flexural Stress at break | MPa | 126 | 155 | 140 | 136 |
| Avg. Deflection temp. | ° C. | 220 | 230 | 234 | 231 |
| Avg. Specific Gravity | — | 1.216 | 1.212 | 1.210 | 1.212 |
| Avg. MVR (275° C./2.16 kg/360 s) | cm³/ | 45.4 | 28.2 | 15.3 | 16.7 |
| | 10 min | | | | |

Thus, to a degree the inventive formulations were able to recover the mechanical properties previously exhibited by the polyamide resins prior to the inclusion of a polyolefin-based color masterbatch. Unnotched Izod impact strength appeared to increase the most

It will be apparent to those skilled in the art that various modifications and variations can be made in the present disclosure without departing from the scope or spirit of the disclosure. Other embodiments of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

The patentable scope of the disclosure is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A resin composite comprising:
from 20 wt. % to 90 wt. % of a polyamide base resin;
from 8 wt. % to 60 wt. % of glass fiber;
from 0.1 wt. % to 10 wt. % of a polyolefin-based color masterbatch; and
from 0.1 wt. % to 20 wt. % of a compatibilizer, wherein
the resin composite exhibits an Izod impact strength greater than 10% of a substantially similar resin composite in the absence of the compatibilizer when tested in accordance with ASTM D256,
the combined weight percent value of all components does not exceed about 100 wt. %, and
all weight percent values are based on the total weight of the composition.

2. A resin composite comprising:
from 20 wt. % to 90 wt. % of a polyamide base resin;
from 8 wt. % to 60 wt. % of glass fiber;
from 0.1 wt. % to 10 wt. % of a polyolefin-based color masterbatch; and
from 0.1 wt. % to 20 wt. % of a maleated polyolefin, wherein
the resin composite exhibits an Izod impact strength greater than 10% of a substantially similar resin composite in the absence of the maleated polyolefin when tested in accordance with ASTM D256,
the combined weight percent value of all components does not exceed about 100 wt. %, and
all weight percent values are based on the total weight of the composition.

3. The resin composite of claim 1, wherein the polyamide base resin comprises polycaprolactam, polyhexamethylene adipamide, Polyhexamethylene sebacamide, polyamide of hexamethylene diamine and n-dodecanedioc acid, polyundecanolactam, polydodecanolactam, polypthalamide, Polyhexamethylene terepthalamide, polyamide of hexamethylenediamine and terephthalic acid, or a combination thereof.

4. The resin composite of claim 1, wherein the polyamide base resin comprises a polyamide having an intrinsic viscosity of from about 2 to about 4.

5. The resin composite of claim 1, wherein the glass fiber is E-glass fiber, S-glass fiber, R-glass fiber, or a combination thereof.

6. The resin composite of claim 1, wherein the glass fiber has a round or a flat cross-section.

7. The resin composite of claim 1, wherein the glass fiber comprises a silane or metallic surface treatment.

8. The resin composite of claim 1, wherein the polyolefin-based color masterbatch comprises a polyethylene or a polypropylene carrier resin.

9. The resin composite of claim 1, wherein the polyolefin-based color masterbatch comprises a low-density polyethylene carrier resin.

10. The resin composite of claim 1, wherein the polyolefin-based color masterbatch has a colorant loading of from 10 wt. % to 70 wt. % of the total weight of the polyolefin-based color masterbatch.

11. The resin composite of claim 1, wherein the compatibilizer comprises a maleated polyolefin.

12. The resin composite of claim 11, wherein the maleated polyolefin comprises a maleated ethylene-propylene copolymer, maleic anhydride-grafted polyethylene copolymer, maleic anhydride-grafted ethylene-propylene-diene monomer, or a maleic anhydride-grafted polyalphaolefin, or a combination thereof.

13. The resin composite of claim 11, wherein the maleated polyolefin comprises a high density polyethylene.

14. The resin composite of claim 11, wherein the maleated polyolefin comprises a maleated ethylene propylene copolymer having a flowrate of 22 g/10 min when tested in accordance with ASTM D1238 and ISO 1133 at 230° C. and 10 kg.

15. The resin composite of claim 1, wherein the resin composite comprises an additive.

16. The resin composite of claim 15, wherein the additive comprises one or more of flow promoters, de-molding agents, a thermal stabilizer, light stabilizer, an ultraviolet absorber, heat stabilizers, process stabilizers, antioxidants, plasticizers, antistatic agents, mold releasing agents, lubricants, flame retardants, or a combination thereof.

17. An article formed from the resin composite of claim 1.

18. A method comprising:
forming a thermoplastic composition comprising:
from 20 wt. % to 90 wt. % of a polyamide base resin;
from 8 wt. % to 60 wt. % of glass fiber;
from 0.1 wt. % to 10 wt. % of a polyolefin based color masterbatch; and
from 0.1 wt. % to 20 wt. % of a compatibilizer, wherein
the resin composite exhibits an Izod impact strength greater than 10% of a substantially similar resin composite in the absence of the maleic anhydride-grafted polyolefin when tested in accordance with ASTM D256,
the combined weight percent value of all components does not exceed about 100 wt. %, and
all weight percent values are based on the total weight of the composition.
